(19) United States
(12) Patent Application Publication
(10) Pub. No.: US 2005/0253556 A1
(43) Pub. Date: Nov. 17, 2005

(54) Battery charging control

(75) Inventor: Tapio Kuiri, Oulu (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/843,865

(22) Filed: May 11, 2004

(51) Int. Cl. H02J 7/00

(52) U.S. Cl. 320/128

(57) ABSTRACT

The invention relates to a battery charging control circuit for controlling a charging of a rechargeable battery by means of a charging component. The battery charging control circuit comprises a switching element, a control component and an energy storage component. The switching element is adapted to connect a battery to a charging component and to disconnect the battery from the charging component. The control component is adapted to control the switching element. The energy storage component is arranged to be loaded by the charging component and to provide a voltage across the energy storage component as a supply voltage to the control component. The invention relates equally to a electronic device comprising such a circuit and to a method of providing a power supply to a control component of such a circuit.

### FIELD OF THE INVENTION

The invention relates to a battery charging control circuit for controlling a charging of a rechargeable battery by means of a charging component. The invention relates equally to a device comprising such a battery charging control circuit and to a method of providing a power supply to a control component of a battery charging control circuit, which control component controls charging a battery with power supplied by a charging component.

### BACKGROUND OF THE INVENTION

The charging of a rechargeable battery by means of a charging component is frequently controlled by a control circuit, in order to enable optimized charging cycles. A charging component is a component which outputs a suitable voltage for the charging, in particular a component which converts an alternating current (AC) voltage provided by AC mains to a suitable direct current (DC) voltage. The battery charging control circuit may be integrated for instance in the electronic device for which the battery is used. In this case, a charger comprising the charging component is connected to the electronic device for charging the battery. Alternatively, the battery charging control circuit may be part of a charger comprising the charging component. In this case, the charger may be adapted to receive the battery which is to be charged or to be connected to the electronic device for which the battery is used.

In order to be able to control the charging, a control component of the battery charging control circuit requires a supply voltage.

In one conventional approach, the voltage provided by the battery itself is used as supply voltage for such a control component. A charging control is very difficult to realize, however, if the battery voltage is very low. The battery voltage is low, if the capacity of the battery is low. This situation is also referred to as a “flat battery charging”.

In another conventional approach, the supply voltage for the control component is therefore provided by a charger. The voltage provided by a charger, however, drops to a very low value, if the charger is connected to an empty (i.e., discharged) battery via a simple switch. When the supply voltage provided by the charger drops to a very low value, the control component cannot maintain its functionality.

It has therefore been proposed to limit the charging current when an empty battery is charged, in order to avoid that the charger voltage drops to a very low value.

The latter approach is illustrated in FIG. 1.

FIG. 1 is a block diagram of a system, in which a charger 19 is connected via a control circuit 11 to a rechargeable battery 18. The control circuit 11 may be for instance integrated into a mobile phase which receives its power supply from the battery 18. The control circuit 11 comprises a control component 12 and a charger switch 13. The charger 19 is connected to the battery 18 more specifically via the charger switch 13, which is controlled by the control component 12. While the battery is basically empty, the control component 12 controls the amount of the charging current provided via the switch 13 to the battery 18. When the battery 18 is loaded at least to a predetermined extent, the control component 12 connects the charger 19 via the switch 13 completely to the battery 18 in suitable charging intervals. The control component 12 receives its power supply directly from the charger 19. In an alternative approach, the control component 12 could be supplied by the charger 19 only when the battery voltage is low, and by the battery 18 whenever the battery voltage is sufficiently high.

This approach has the disadvantage, though, that it results in a high thermal dissipation whenever the battery 18 is basically empty. The reason for the thermal dissipation is that there is a high voltage drop over the switch 13 and at the same time a relatively high charging current. The high voltage drop is caused by a high potential difference between the charger 19 and the empty battery 18. The charging current is selected to be rather high in order to ensure that the battery 18 is charged in a sensible time.

The charger voltage may be for instance 12V and the charger output impedance 10 Ohm. If a constant charging current of 100 mA is used, then the dissipated power in the charger switch 13 is 150 mA*(12V-10 Ohm*150 mA)=1.575 W.

Such a high thermal dissipation can lead to a high temperature in the device comprising the battery 18 and the battery charging control circuit 11, which may cause reliability problems in the components of the device. High temperatures and high voltages are in particular an increasing problem when aiming at downscaling silicon processes used in chips which comprises the battery charging control circuit 11.

### SUMMARY OF THE INVENTION

It is an object of the invention to improve the power supply to a control component of a battery charging control circuit.

A battery charging control circuit for controlling a charging of a rechargeable battery by means of a charging component is proposed. The proposed battery charging control circuit comprises a switching element, a control component and an auxiliary energy storage component. The switching element is adapted to connect a battery to a charging component and to disconnect the battery from the charging component, respectively. The control component is adapted to control the switching element. The energy storage component is arranged to be loaded by a charging component and to provide a voltage across said energy storage component as a supply voltage to the control component.

Moreover, an electronic device comprising such a battery charging control circuit is proposed.

Finally, a method of providing a power supply to a control component of a battery charging control circuit is proposed. The battery charging control circuit controls charging a battery with power supplied by a charging component. The proposed method comprises loading an auxiliary energy storage component of the battery charging control circuit by means of power supplied by the charging component. The proposed method further comprises providing a voltage across said energy storage component as supply voltage to the control component.

The invention proceeds from the consideration that a stable power supply to a control component can be obtained from the voltage provided by a charging component used for charging a battery, if an auxiliary energy storage component is employed as intermediate component. It is therefore proposed that an energy storage component is loaded by the charging component, for instance in between different charging periods in which the battery is charged. The energy storage component is then able to provide a relatively stable supply voltage to the control component as well during the charging periods.

It is an advantage of the invention that it enables an empty battery to be charged reliably and at the same time with a low thermal dissipation. The reliability is achieved with the stable voltage provided to the control component by the energy storage component. A low thermal dissipation can be ensured, since the control component is no longer dependent on a direct voltage supply from the charging component. This allows closing a switching element connecting the battery to the charging element completely also when charging an empty battery. When the charging current is not limited, the thermal dissipation will be much lower due to the lower potential difference between the charger output and the battery input.

Even though the invention is of particular advantage when charging an empty battery, it is understood that the energy storage component can be employed as well for providing a supply voltage to the control component when charging partially or fully charged batteries. In case the voltage across the battery is high enough, the voltage provided by the charging component does not drop when it is connected to the battery. In this case, the energy storage component can therefore also be loaded while the charging component is connected to the battery.

In one embodiment of the invention, a battery charging control circuit comprises moreover an additional switching element associated to the energy storage component. This additional switching element is adapted to connect the energy storage component to the charging component and to disconnect the energy storage component from the charging component, respectively. The additional switching element thus enables an adjustment of the loading of the energy storage component.

In one embodiment of the invention, the additional switching element is controllable, for example by the control component. The additional switching element might comprise to this end for example a controllable operational amplifier or a controllable simple switch. Such a controllable switch can be realized for instance with a transistor, like a MOSFET. The additional switching element might also comprise an operational amplifier and a switch connected between the operational amplifier and the energy storage component. The control component may then be able to cause the energy storage component to be loaded at least in between the charging periods by controlling the additional switching element. The loading via the additional switching element may depend in addition on the presence of a minimal voltage provided by the charging component. The additional switching element ensures that a leakage current from the energy storage component is minimized while the energy storage component is not loaded.

In another embodiment of the invention, the additional switching element does not require any control, but connects the energy storage component to the charging component and disconnects the energy storage component from the charging component depending on the voltage currently provided by the charging component and the voltage across the energy storage component. Such an additional switching element can comprise for example a diode. In this case, the energy storage component is always loaded when the voltage provided by the charging component is higher than the diode threshold voltage plus the voltage across the energy storage component. If voltage provided by the charging component is smaller, the diode automatically prevents a discharge of the energy storage component to the charging component.

The energy storage component may comprise for example a capacitor or a small battery. Also a combined use of a capacitor and a small battery as energy storage component is possible. For example, in case the main battery has enough voltage, it may be used for providing the control component with a supply voltage. In case the main battery is flat, then a small back-up battery is used for providing the control component with a supply voltage. This small back-up battery may be for instance a battery which is mainly used to run a ‘real-time clock’. In case the small back-up battery is flat as well, then the capacitor is used for providing the control component with a supply voltage. The capacitor might also be needed if a back-up battery is available, but not able to be loaded fast enough to start the main battery charging.

In a further embodiment of the invention, the control component comprises a logic and an oscillator. The logic realizes a state machine for controlling the switching element and/or for causing the energy storage component to be loaded. The oscillator, which could be for instance a resistor-capacitor (RC) oscillator or a crystal oscillator, provides a clock signal for running the logic.

In a further embodiment of the invention, the control component is adapted to perform additional tasks, in particular though not necessarily when the battery is not connected by the switching element to the charging component. Such an additional task may be for example measuring the temperature in the battery charging control circuit.

In an exemplary embodiment of the invention, the battery charging control circuit is integrated on a chip.

The electronic device according to the invention can be a separate electronic device for the battery charging control circuit. It can further be a charger comprising in addition to the battery charging control circuit the charging component. It can further be an electronic device which comprises components obtaining their power supply by the battery, for example a mobile phone. In this case, the device comprises an input terminal for connecting a charger including of a charging component. The formulation ‘including a charging component’ refers also to the case in which the charger consists exclusively of the charging component.

In an embodiment of the method according to the invention, the method comprises a repeating duty cycle, which can be employed in particular whenever the battery is basically empty. In this duty cycle, first a loading of the energy storage component is started. After a first period of time, the loading is stopped again. After a second period of time, a charging of the battery is started. After a third period of time, charging the battery is stopped again. These steps are continuously repeated after a fourth period of time until the battery is fully charged. Obviously, however, the steps can only be repeated as long as the charging component provides power to the battery charging control circuit.

The control component is then able to adjust the average charging current for charging the battery as desired by adjusting at least one of the first, the second, the third and the fourth period of time. The desired average charging current is determined in a conventional way.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of a conventional system for charging a battery;

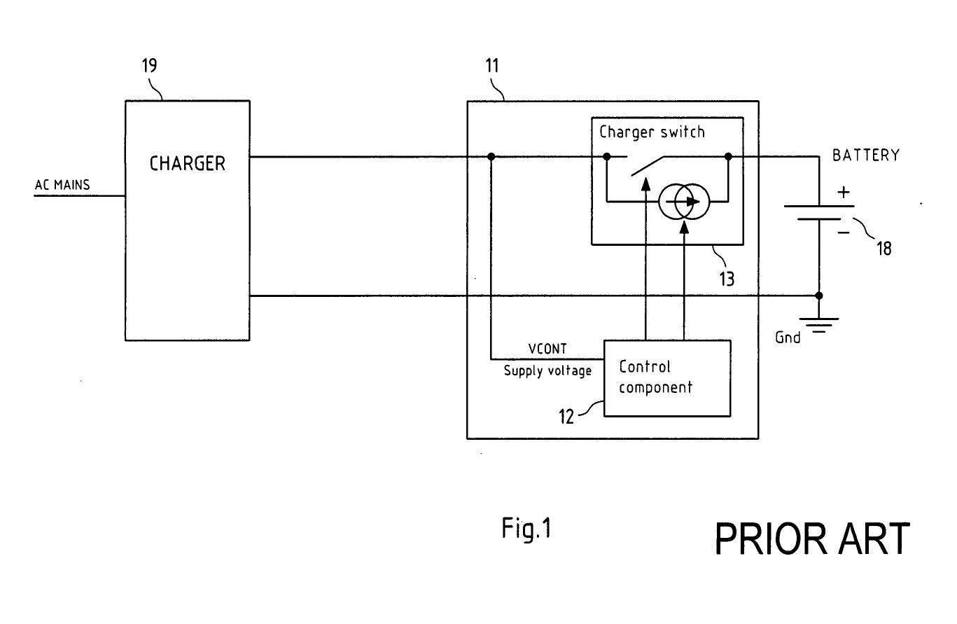

FIG. 2 is a schematic block diagram of a system for charging a battery in accordance with a first embodiment of the invention;

FIG. 3 is a flow chart illustrating the operation of a linear regulator in the system of FIG. 2;

FIG. 4 is a flow chart illustrating the operation of a control component in the system of FIG. 2;

FIG. 5 presents diagrams for a battery voltage, a charger voltage, a supply voltage, the state of a charger switch and the state of a POWER DOWN signal for respectively two charging periods in the system of FIG. 2;

FIG. 6 is a schematic block diagram of a system for charging a battery in accordance with a second embodiment of the invention; and

FIG. 7 is a schematic block diagram of a system for charging a battery in accordance with a third embodiment of the invention.

### DETAILED DESCRIPTION OF THE INVENTION

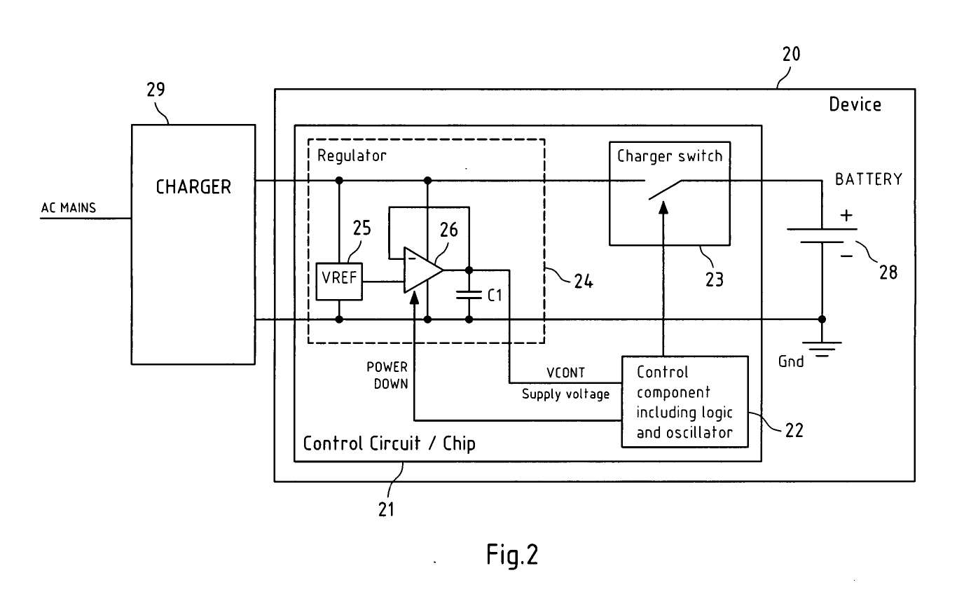

FIG. 2 is a schematic block diagram of a system for charging a rechargeable battery. In this system, a control component of a battery charging control circuit is provided with a supply voltage in accordance with an embodiment of the invention.

The system comprises an electronic device 20 which is supplied with power by a rechargeable battery 28. The system further comprises a charger 29 for charging the battery 28. For charging the battery 28, the charger 29 is connected on the one hand to the AC mains, and on the other hand to the electronic device 20.

The electronic device 20, which can be for example a mobile phone, comprises besides the rechargeable battery 28 a battery charging control circuit 21. The battery charging control circuit 21 may be integrated on a chip and includes a control component 22, a charger switch 23 and a linear regulator 24. The control component 22 comprises a logic realizing a state machine, which is run by a clock signal. The clock signal can be generated for instance by an RC oscillator or by a crystal oscillator of the control component 22.

When the charger 29 is connected to the electronic device 20, a first output terminal of the charger 29 is connected via the charger switch 23 to a first terminal of the battery 28. A second output terminal of the charger 29 and a second terminal of the battery 28 are both connected within the electronic device 20 to ground Gnd.

Within the regulator 24, the two output terminals of the charger 29 are connected in addition to voltage supply terminals of a reference voltage generator 25 and of an operational amplifier 26, respectively. The output of the operational amplifier 26 is coupled back to a first input of the operational amplifier 26, while the output of the reference voltage generator 25 is connected to a second input of the operational amplifier 26. The regulator further comprises a capacitor Cl, which is arranged between the output of the operational amplifier 26 and ground Gnd.

The control component 22 has a controlling access to the charger switch 23 and to the operational amplifier 26. The voltage across the capacitor Cl is applied as supply voltage VCONT to the control component 22.

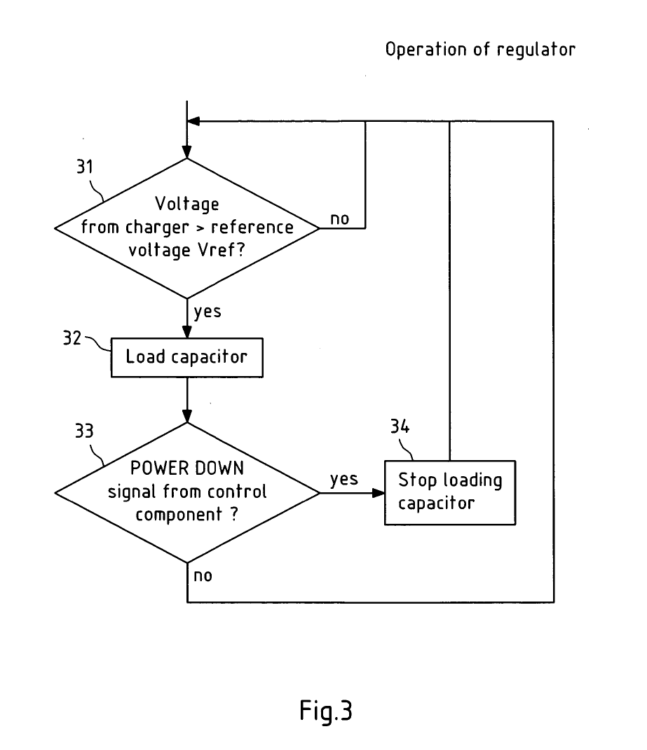

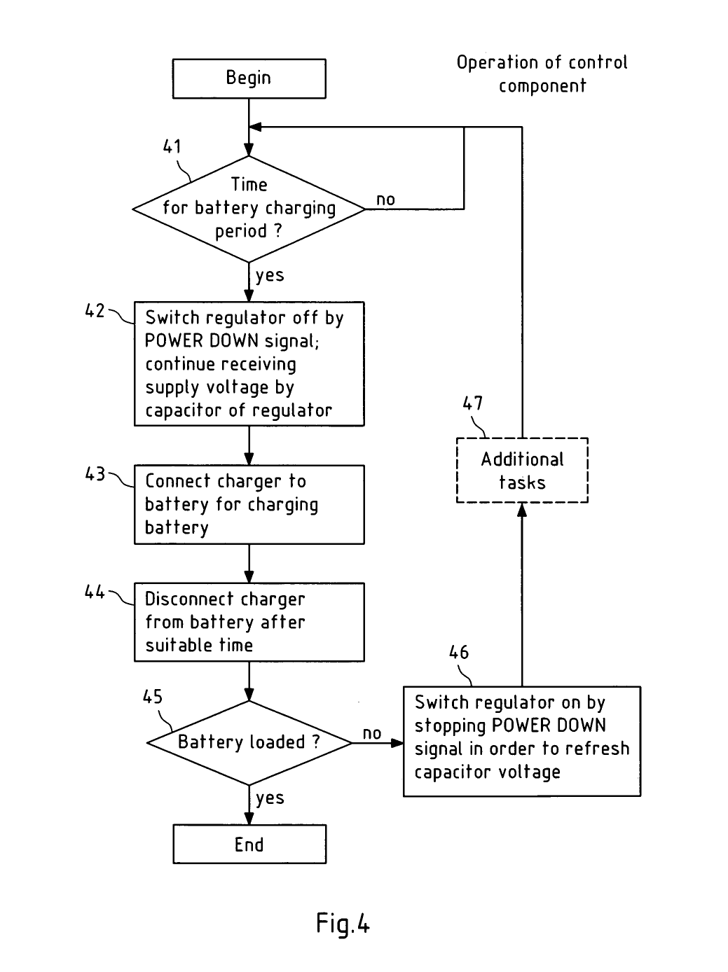

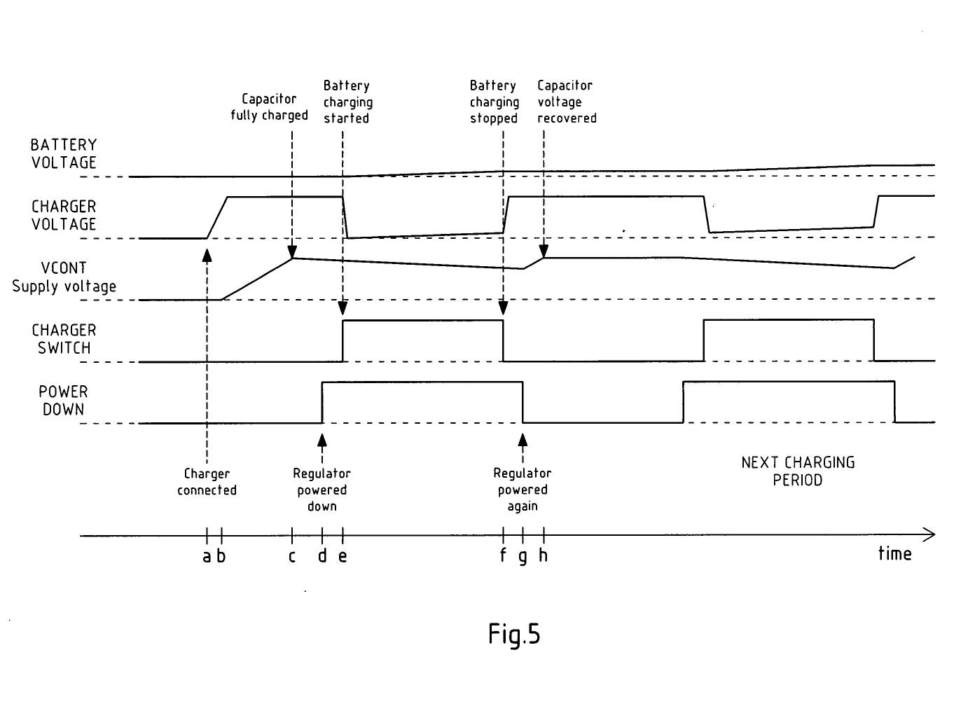

The charging of the battery 28 in the system of FIG. 2 will now be explained with reference to FIGS. 3, 4 and 5. FIG. 3 is a flow chart illustrating the operation of the linear regulator 24, while FIG. 4 is a flow chart illustrating the operation of the control component 21. FIG. 5 presents five diagrams illustrating the course of events over time for respectively two charging periods. On an associated time line arranged below the five diagrams, specific points of time a) to h) are indicated. The first diagram indicates the battery voltage over time. The second diagram illustrates the voltage provided by the charger 29 over time. The third diagram indicates the supply voltage VCONT provided by the capacitor Cl to the control component 22 over time. The fourth diagram illustrates the state of the charger switch 23 over time. The fifth diagram, finally, illustrates the value of a POWER DOWN signal provided by the control component 22 to the regulator 24 over time.

When the charger 29 is connected to the AC mains, it converts the provided AC voltage to a DC voltage and offers this DC voltage at its output terminals. When the charger 29 is further connected to the device 20 at a point of time a), the charger voltage at the input of the device 20 increases quickly to the maximum output voltage of the charger 29. This voltage is applied as supply voltage to the reference voltage generator 25 and to the operational amplifier 26, respectively. The reference voltage generator 25 generates thereupon a reference voltage VREF, which lies somewhat below the maximum output voltage of the charger 29. The output voltage of the charger 29 and the reference voltage VREF are provided to a respective input of the operational amplifier 26.

By default, the operational amplifier 26 is switched on. The operational amplifier 26 compares the input voltages, which is indicated in FIG. 3 as a step 31. As soon as the voltage provided by the charger 29 is sufficiently high at a point of time b), the operational amplifier 26 is caused to apply a voltage to the capacitor C1. This is indicated in FIG. 3 as a step 32.

The capacitor C1 is thereby loaded until it is fully charged at a point of time c). The voltage across the capacitor C1 is provided as supply voltage to the control component 22. The control component 22 may thus start to operate as soon as the supply voltage is sufficiently high. The operation includes in particular running the comprised logic in accordance with the clock signal provided by the comprised oscillator, as illustrated in FIG. 4.

When the control component 22 determines that it is time to charge the battery 28, the control component 22 first powers down the regulator 24 by providing a high-level POWER DOWN signal to the operational amplifier 26 at a point of time d). This is indicated in FIG. 4 as steps 41 and 42. As a result, the operational amplifier 26 stops charging the capacitor C1. This is indicated in FIG. 3 as steps 33 and 34. Due to the capacitor load, the control component 22 is nevertheless further provided with a supply voltage, which is slowly decreasing as the capacitor C1 is discharged. While the capacitor C1 is not loaded by the operational amplifier 26, the current consumption by the control component 22 should be minimized, in order to prevent a too extensive discharging of the capacitor C1. Further, a leakage current from the capacitor C1 through the regulator 24 during this time has to be prevented by the operational amplifier 26. Such a leakage current could also be achieved with a separate serial switch.

Next, the control component 22 causes the charger switch 23 to connect the charger to the battery 28 at a point of time e). This is indicated in FIG. 4 as a step 43. As a result, there is a drop of the charger voltage, which increases slowly again as the battery 28 is charged.

After a suitable charging period, the control component 22 causes the charger switch 23 to disconnect the charger again from the battery 28 at a point of time f). This is indicated in FIG. 4 as a step 44.

In case the battery 28 is not loaded completely yet, the control component 22 then powers up the operational amplifier 26 again at a point of time g) by providing a low-level POWER DOWN signal to the operational amplifier 26 again. This is indicated in FIG. 4 as steps 45 and 46. As a result, the operational amplifier 26 charges the capacitor C1 again until its voltage is recovered at a point of time h), if the charger 29 is still connected to the device 20 to provide a voltage exceeding the reverence voltage VREF. This is indicated in FIG. 3 again as steps 31 and 32.

The described process is continued for as many charging periods as are required to fully charge the battery 28. The average charging current is controlled by the control component 22 by controlling the duty cycles of charging, in particular the length and/or the frequency of the charging periods. It has to be taken care that the regulator 24 is powered on between each charging period sufficiently long for allowing the capacitor voltage to recover completely.

During the periods of time in which the battery 28 is not charged, additional tasks may be carried out by the control component 22, for example temperature measurements which may then be taken into account in the adjustment of the duty cycles. This is indicated in FIG. 4 with dotted lines as step 47.

In an exemplary implementation of the presented system, the capacitance of the capacitor C1 may be C=1 μF. Further, one charging period may have a length of T=10 ms. The voltage drop in the capacitor C1 can be 1V during the charging.

As the product of capacitance C and voltage U is equal to the product of the current I and time T, that is CU=IT, the maximal current I(max) drawn from the capacitor can be determined to be I(max)=CU/T=100 μA.

Thus, in the exemplary implementation, the control component should use less than 100 μA for its operation.

The current consumption of different components of the control circuit 21 can be estimated for example as follows: A 32 kHz crystal oscillator, which may be used for providing the clock signal to the logic of the control component 22, requires less than 10 μA for its operation. The logic of a control component 22 requires equally less than 10 μA for its operation. Also a voltage reference generator 25 requires less than 10 μA for its operation, etc. Therefore, the requirement that the control circuit 21 should use less than 100 μA for its operation is feasible.

On the whole, it becomes apparent that the proposed system enables a stable voltage supply to the control component of a battery charging control circuit while preventing at the same time the disadvantage of a high thermal dissipation while the battery is basically empty.

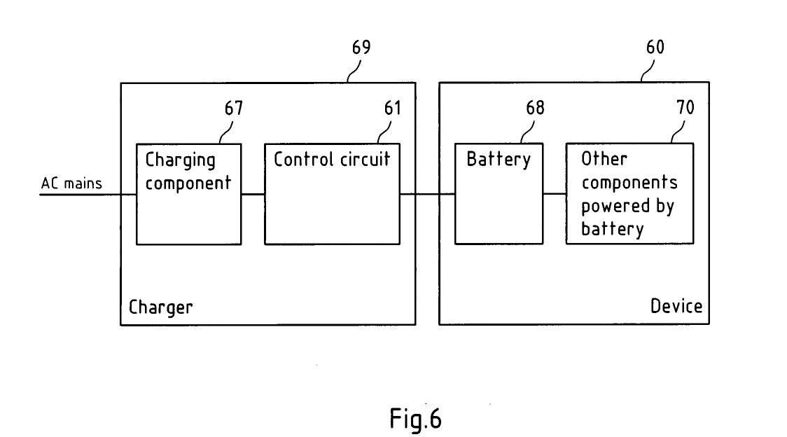

FIG. 6 is a schematic block diagram of another system for charging a rechargeable battery. The system comprises a charger 69 and a device 60. The charger 69 includes a charging component 67 which corresponds to the charger 29 of FIG. 2 and a control circuit 61 which corresponds to the control circuit 21 of FIG. 2. The device 60 includes a battery 68 which corresponds to the battery 28 of FIG. 2 and other components 70 which are powered by the battery. Such other components are not depicted in the device 20 of FIG. 2 but obviously included there as well. It has to be noted that the charger 69 could also be adapted to be connected directly to a separate battery 68, instead of to a device 60 comprising the battery 68.

The only difference between the system of FIG. 6 and the system of FIG. 2 is thus that the control component is integrated in a charger instead of in a device comprising the battery. Also the operation of the corresponding components is the same as described for the system of FIG. 2.

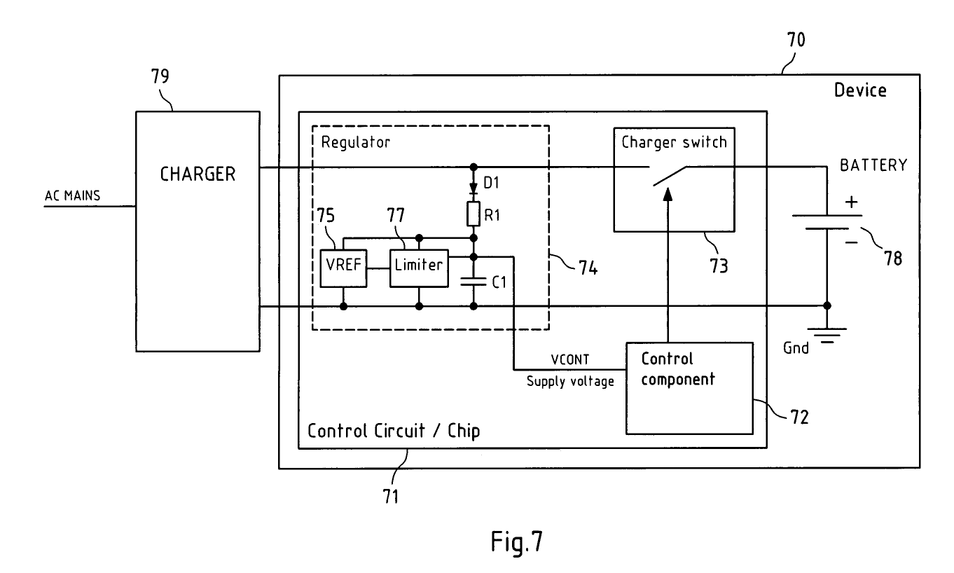

FIG. 7 is a schematic block diagram presenting a variation in the control circuit 21 of the system of FIG. 2.

The system of FIG. 7 comprises a charger 79 and a device 70 including a battery 78 and a control circuit 71, which are arranged in the same way as corresponding components of FIG. 2. The control circuit 71 moreover comprises a regulator 74, a charger switch 73 and a control component 72, which are arranged in the same way as corresponding components of FIG. 2.

The regulator 74, however, is realized in a different manner than the regulator 24 of FIG. 2. Moreover, the control component 72 is not adapted to control the regulator 74, but only the charger switch 73.

In the regulator, the output of the charger 79 is connected via a diode D1, a resistor R1 and a capacitor C1 to ground Gnd. In addition, a reference voltage generator 75 and a limiter 77 are connected with their respective voltage supply terminals in parallel to the capacitor C1. The output of the reference voltage generator 75 is provided as input to the limiter 77. The connection between the resistor R1 and the capacitor C1 is connected to a further input of the limiter 77.

The voltage across the capacitor Cl is provided as supply voltage VCONT to the control component 72.

With the regulator 74 of FIG. 7, the capacitor C1 is always loaded, when the voltage of the charger 79 is higher that the voltage across the capacitor C1 plus the voltage drop across the diode D1. When the charging switch 73 is closed, the voltage provided by the charger 79 drops, but the diode D1 prevents that the capacitor C1 is discharged to the charger line. Thus, the system of FIG. 7 has the advantage that it is particularly simple, as no POWER DOWN signal has to be provided by the control component 72 to the regulator 74.

The limiter 77 limits the maximum voltage over the capacitor C1, in order to avoid that the device 70 breaks down due to a too high voltage. The reference voltage generator 75 generates a corresponding reference voltage VREF and provides it to the limiter 77.

The reference voltage generator 75 and the limiter 77 are assumed to consume very little current.

The resistor R1 limits the current to the capacitor C1 in addition, which is of particular relevance in the case a high voltage is provided by the charger 79.

While there have been shown and described and pointed out fundamental novel features of the invention as applied to a preferred embodiment thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A battery charging control circuit for controlling a charging of a rechargeable battery by means of a charging component, said battery charging control circuit comprising a switching element, a control component and an auxiliary energy storage component,
wherein said switching element is adapted to connect a battery to a charging component and to disconnect said battery from said charging component, respectively;
wherein said control component is adapted to control said switching element; and
wherein said energy storage component is arranged to be loaded by a charging component and to provide a voltage across said energy storage component as a supply voltage to said control component.

2. The battery charging control circuit according to claim 1, further comprising an additional switching element adapted to connect said energy storage component to said charging component and to disconnect said energy storage component from said charging component, respectively.

3. The battery charging control circuit according to claim 2, wherein said control component is further adapted to cause said energy storage component to be loaded by a charging component at least during periods of time in which said charging component is not connected via said switching element to a battery by controlling said additional switching element.

4. The battery charging control circuit according to claim 2, wherein said additional switching element is adapted to connect said energy storage component to a charging component and to disconnect said energy storage component from said charging component depending on a difference between a voltage currently supplied by said charging component and a voltage across said energy storage component.

5. The battery charging control circuit according to claim 2, further comprising a reference voltage generator providing a predetermined reference voltage, wherein said additional switching element is adapted to connect said energy storage component to said charging component only when a voltage provided by said charging component exceeds a reference voltage provided by said reference voltage generator.

6. The battery charging control circuit according to claim 2, wherein said additional switching element comprises at least one of an operational amplifier, a transistor and a diode.

7. The battery charging control circuit according to claim 1, wherein said energy storage component comprises at least one of a capacitor and a battery.

8. The battery charging control circuit according to claim 1, wherein said control component comprises a logic and an oscillator, said logic realizing a state machine for controlling said switching element and for causing said energy storage component to be loaded, and said oscillator providing a clock signal for running said logic.

9. The battery charging control circuit according to claim 1, wherein said control component is adapted to perform additional tasks.

10. The battery charging control circuit according to claim 1, wherein said battery charging control circuit is integrated on a chip.

11. An electronic device comprising a battery charging control circuit for controlling a charging of a rechargeable battery by means of a charging component, said battery charging control circuit including a switching element, a control component and an auxiliary energy storage component,
wherein said switching element is adapted to connect a battery to a charging component and to disconnect said battery from said charging component, respectively;
wherein said control component is adapted to control said switching element and to cause said energy storage component to be loaded by a charging component during periods of time in which said charging component is not connected via said switching element to a battery; and
wherein said energy storage component is arranged to provide a voltage across said energy storage component as a supply voltage to said control component.

12. The electronic device according to claim 11, wherein said battery charging control circuit further comprises an additional switching element adapted to connect said energy storage component to said charging component and to disconnect said energy storage component from said charging component, respectively.

13. The electronic device according to claim 12, wherein said control component is further adapted to cause said energy storage component to be loaded by a charging component at least during periods of time in which said charging component is not connected via said switching element to a battery by controlling said additional switching element.

14. The electronic device according to claim 12, wherein said additional switching element is adapted to connect said energy storage component to a charging component and to disconnect said energy storage component from said charging component depending on a difference between a voltage currently supplied by said charging component and a voltage across said energy storage component.

15. The electronic device according to claim 12, further comprising a reference voltage generator providing a predetermined reference voltage, wherein said additional switching element is adapted to connect said energy storage component to said charging component only when a voltage provided by said charging component exceeds a reference voltage provided by said reference voltage generator.

16. The electronic device according to claim 12, wherein said additional switching element comprises at least one of an operational amplifier, a transistor and a diode.

17. The electronic device according to claim 11, wherein said energy storage component comprises at least one of a capacitor and a battery.

18. The electronic device according to claim 11, wherein said control component comprises a logic and an oscillator, said logic realizing a state machine for controlling said switching element and for causing said energy storage component to be loaded, and said oscillator providing a clock signal for running said logic.

19. The electronic device according to claim 11, wherein said control component is adapted to perform additional tasks when said battery is not connected by said switching element to said charging component.

20. The electronic device according to claim 11, wherein said battery charging control circuit is integrated on a chip.

21. The electronic device according to claim 11, wherein said electronic device is a charger comprising said charging component.

22. The electronic device according to claim 11, which electronic device comprises an input terminal for connecting a charger including a charging component, and which electronic device comprises components which are arranged to obtain their power supply from said battery.

23. A method of providing a power supply to a control component of a battery charging control circuit, which control component controls charging a battery with power supplied by a charging component, said method comprising:
loading an auxiliary energy storage component of said battery charging control circuit by means of power supplied by said charging component; and
providing a voltage across said auxiliary energy storage component as supply voltage to said control component.

24. The method according to claim 23, wherein said auxiliary energy storage component is only loaded when said charging component is not connected by said battery charging control circuit to a battery.

25. The method according to claim 23, wherein loading said energy storage component and charging said battery comprises the following duty cycle:
a) begin loading said energy storage component;
b) stop loading said energy storage component after a first period of time;
c) begin charging said battery after a second period of time;
d) stop charging said battery after a third period of time; and
e) continue with step a) after a fourth period of time, as long as said charging component provides power to said battery charging control circuit, until said battery is charged to a desired level.

26. The method according to claim 25, wherein an average charging current for charging said battery is adjusted by adjusting at least one of said first period of time, said second period of time, said third period of time and said fourth period of time.

27. The method according to claim 23, wherein said energy storage component is only loaded when a voltage supplied by said charging component exceeds an available reference voltage.
